(19) United States
(12) Patent Application Publication
(10) Pub. No.: US 2024/0094436 A1
(43) Pub. Date: Mar. 21, 2024

(54) HIGH-RESOLUTION STANDARDIZED PRECIPITATION EVAPOTRANSPIRATION INDEX DATASET DEVELOPMENT METHOD BASED ON RANDOM FOREST REGRESSION MODEL

(71) Applicant: Henan University, Zhengzhou (CN)

(72) Inventors: Haoming Xia, Kaifeng (CN); Yaochen Qin, Kaifeng (CN)

(21) Appl. No.: 18/467,764

(22) Filed: Sep. 15, 2023

(30) Foreign Application Priority Data
Sep. 15, 2022 (CN) 2022111232168

(51) Int. Cl. G01W 1/14; G06N 20/20

(52) U.S. Cl. CPC G01W 1/14; G06N 20/20

(57) ABSTRACT

A high-resolution SPEI dataset development method based on a random forest regression model is provided. In the method, meteorological station data, GPM remote sensing precipitation data, MODIS land surface temperature data, ERA5-Land shortwave radiation data and SRTM digital elevation model data are combined; and a spatial pattern of SPEI index at different time scales of a target area is predicted by constructing a spatiotemporal relationship between the SPEI index and the precipitation, land surface temperature, shortwave radiation and elevation data. The method fully utilizes advantages that the random forest is high in precision and avoids overfitting in model prediction, and inputs station data and remote sensing and reanalysis data simultaneously into the model for training, which can solve problems of mismatch of an existing SPEI dataset with the station data and low spatial resolution, and the spatial resolution of SPEI dataset is effectively improved.

### TECHNICAL FIELD

The invention relates to the field of high-resolution earth system scientific dataset development technologies, and particularly to a high-resolution standardized precipitation evapotranspiration index (SPEI) dataset development method based on a random forest regression model.

### BACKGROUND

Drought disasters are usually defined as a series of hydrological imbalances caused by extreme climatic conditions such as insufficient precipitations and abnormal temperatures. At present, the drought disasters are considered to be the most complex, difficult to understand and cannot be accurately predicted by scientific means in the world. In recent decades, under the background of global warming, drought disasters caused by extreme climatic conditions have become more and more frequent, which has brought great impact on the global natural environment and human society, thus having aroused great concern of the international community on the drought disasters. Therefore, it is very important to use scientific methods to accurately identify occurrences, developments and end times of drought events, which is of great practical significance for in-depth exploration of causes of drought disasters and their adverse effects on the ecological environment, as well as for the prevention and control of drought disasters.

The use of a reasonable drought index can effectively identify occurrence processes of drought events. Currently, numerous drought indices have been developed by scientists, and the most widely used drought indices include the palmer drought severity index (PDSI), the standardized precipitation index (SPI), and the standardized precipitation evapotranspiration index (SPEI). Although the PDSI and SPI indices have been widely accepted by the international community, they still have some limitations. For example, the SPI index only considers precipitation information and ignores the influence of evapotranspiration on regional dry and wet changes. Although the PDSI index comprehensively considers interrelationships between precipitation as well as evapotranspiration, and drought; its calculation method relies heavily on data calibration and thus lacks spatial comparability. Compared with the PDSI and SPI indices, the SPEI index not only takes into account comprehensive effects of precipitation and evapotranspiration on drought, but also has better comparable characteristics in time and space. Therefore, the SPEI index can be used to more accurately analyze spatiotemporal evolution features of drought at the national scale in the context of climate change.

Nowadays, existing SPEI datasets in the world still have problems of low spatial resolution and the spatiotemporal discontinuity. Although these datasets can effectively identify occurrence processes of drought events, they are still more suitable for qualitative analysis of the drought events. These data with the low spatial resolution and the spatiotemporal discontinuity would lead to excessive errors when a method based on probability and statistics is used to quantitatively analyze the drought events.

### SUMMARY

Aiming at the problems of mismatch between the existing SPEI dataset and station data and the low spatial resolution, an embodiment of the invention provides a high-resolution SPEI dataset development method based on a random forest regression model, which combines meteorological station data, remote sensing data, reanalysis data and the random forest regression model, and is capable of developing a SPEI dataset with a spatial resolution of 1 km in China for the years 2001 to 2020, and thus lays a solid foundation for in-depth research on drought.

To achieve the above objective, technical solutions of embodiments of the invention are as follows.

Specifically, a high-resolution SPEI dataset development method based on a random forest regression model includes:
step 1, acquiring daily meteorological station information of a target area in a study/research period through a national meteorological science data center and removing erroneous observations by using Python programming language technology (to obtain daily meteorological information), and finally converting the daily meteorological information into monthly meteorological information;
step 2, based on the monthly meteorological information obtained in the step 1, calculating monthly potential evapotranspiration (PET) information on a station according to a FAO Penman-Monteith formula;
step 3, calculating differences of precipitation and potential evapotranspiration (precipitation—potential evapotranspiration) according to precipitation information obtained in the step 1 and the potential evapotranspiration information obtained in the step 2, and constructing time series of cumulative differences of precipitation and potential evapotranspiration at multiple time scales (such as 1 month, 3 months, 6 months, 9 months, 12 months, and 24 months);
step 4, calculating SPEIs at different time scales (such as SPEI-1, SPEI-3, SPEI-6, SPEI-9, SPEI-12 and SPEI-24, respectively corresponding to the 1 month, the 3 months, the 6 months, the 9 months, the 12 months and the 24 months) of the station according to information of the time series of cumulative differences of precipitation and potential evapotranspiration at the different time scales obtained in the step 3;
step 5, acquiring GPM precipitation data, MODIS land surface temperature data, ERA5-Land shortwave radiation data, and SRTM digital elevation model (DEM) data, based on a Google earth engine (GEE) cloud platform; and performing cloud removal processing on the MODIS land surface temperature data;
step 6, removing seasonality of the precipitation data, the land surface temperature data, and shortwave radiation data obtained in the step 5 and then converting them into monthly data, and then resampling spatial resolutions of the precipitation data, the land surface temperature data, the shortwave radiation data and the elevation data to 1 kilometer (km) through a bicubic interpolation algorithm;
step 7, forming/composing sample points by information of the SPEIs at the different time scales obtained in the step 4 and data values at the station of the precipitation data, the land surface temperature data, the shortwave radiation data and the elevation data in the step 6;
step 8, constructing the random forest regression model according to the sample points obtained in the step 7, wherein 80% of the sample points are randomly selected as training samples, and 20% of the sample points are used as testing samples; and
step 9, inputting the precipitation data, the land surface temperature data, the shortwave radiation data and the elevation data obtained in the step 6 into the random forest regression model constructed in the step 8 for prediction, and thereby obtaining a standardized precipitation evapotranspiration index (SPEI) dataset with a spatial resolution of 1 km for the target area in the study period.

In an embodiment, in the step 2, the potential evapotranspiration (PET) information is calculated as follows:

$$PET = \frac{0.408 Δ ( {R}_{n} - G ) + γ \frac{900}{T + 273} {μ}_{2} ( {e}_{a} - {e}_{d} )}{Δ + γ ( 1 + 0.34 {u}_{2} )}$$

where Δ represents a slope of a relationship curve between saturation vapor pressure and temperature, Rₙ represents a net radiation, G represents a soil heat flux, γ represents a hygrometer constant, T represents a temperature, μ₂ represent an average wind speed, eₐ represents a saturation vapor pressure, and e_{d} represents an actual vapor pressure.

In an embodiment, in the step 3, the cumulative difference of precipitation and potential evapotranspiration is calculated as follows:

X_{i,j}^{k=Σ}ᵢ₌₁₃₋ₖ₊ⱼ¹²D_{i-1,l}+Σᵢ₌₁^{j}D_{i,l},if j<k

X_{i,j}^{k=Σ}ᵢ₌ⱼ₋ₖ₊₁^{j}D_{i,l},if j≥k

where X_{i,j}^{k} represents a cumulative value of differences of precipitation and potential evapotranspiration at the time scale of k months for a j-th month in an i-th year, and D_{i,l} represents the difference of precipitation and potential evapotranspiration for a l-th month in the i-th year.

In an embodiment, in the step 4, the SPEI is calculated as follows:

$$f ( x ) = \frac{β}{a} {{( \frac{x - γ}{a} )}^{β - 1} [ 1 + {( \frac{x - γ}{a} )}^{β} ]}^{- 2}$$

$$F ( x ) = {[ 1 + {( \frac{a}{x - γ} )}^{β} ]}^{- 1}$$

$$SPEI = \sqrt{- 2 ln ( P )} - \frac{{c}_{0} + {c}_{1} W + {c}_{2} {W}^{2}}{1 + {d}_{1} W + {d}_{2} {W}^{2} + {d}_{3} {W}^{3}}$$

$$P = 1 - F ( x ) , if F ( x ) \leq 0.5$$

$$P = F ( x ) , if F ( x ) > 0.5$$

where ƒ(x) represents a probability density function, F(x) represents a probability distribution function, a represents a scale parameter, β represents a shape parameter, γ represents a position parameter, c₀, c₁, c₂, d₁, d₂, and d₃ represent constants each greater than zero, and P represents an intermediate parameter.

In an embodiment, in the step 5, the cloud removal processing is performed as follows:
removing clouds, cloud shadows, cirrus clouds, and ice and snow cover observations from satellite images through a quality band cloud removal algorithm, to thereby obtain a high-quality satellite image dataset.

In an exemplary embodiment, the high-resolution SPEI dataset development method based on the random forest regression model further comprising: applying the SPEI dataset with the spatial resolution of 1 km to identify regional drought events in the target area, for example to identify occurrence times, development processes and ending times of the regional drought events in the target area.

Compared with the prior art, the various embodiments of the invention may achieve beneficial effects as follows.
(1) the method has characteristics of higher operation speed, higher prediction accuracy, and overfitting resistance;
(2) the method fully utilizes meteorological station observation data, remote sensing data and reanalysis data, the calculation accuracy of SPEI index is guaranteed, the generated SPEI dataset can accurately identify occurrence times, development processes and ending times of regional drought events, and thus the method has guiding significance for further deepening of drought monitoring and identification research; and
(3) the SPEI dataset developed by the method has higher spatial resolution and can provide a more refined description of detailed features of drought in spatial distribution, thus laying the foundation for precise identification and quantitative research of drought events.

### BRIEF DESCRIPTION OF DRAWINGS

FIG. 1 illustrates a schematic flowchart of a high-resolution SPEI dataset development method based on a random forest regression model according to an embodiment of the invention.

FIG. 2 illustrates a schematic cross-validation result diagrams generated according to an embodiment of the invention.

FIG. 3 illustrates SPEI time series variation/change curve diagrams generated according to an embodiment of the invention.

FIG. 4 illustrates monthly SPEI spatial distribution diagrams in the year 2015 generated according to an embodiment of the invention.

FIG. 5 illustrates SPEI spatial accuracy evaluation diagrams generated according to an embodiment of the invention.

### DETAILED DESCRIPTION OF EMBODIMENTS

The invention will be further explained with reference to the accompanying drawings and exemplary embodiments.

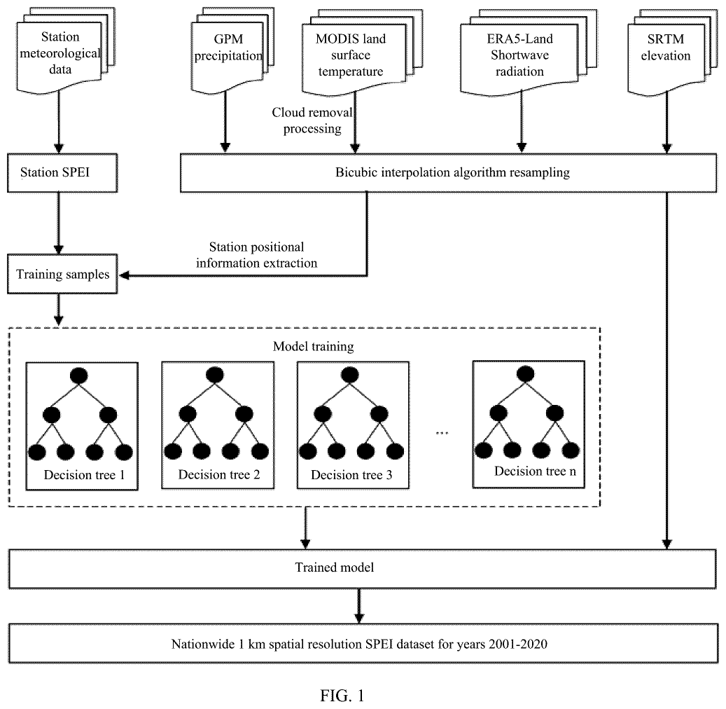

As illustrated in FIG. 1, a high-resolution SPEI dataset development method based on a random forest regression model, includes step S1 through step S9 as follows.

Step S1, acquiring daily meteorological station information of a target area/region in a study/research period through a national meteorological science data center and removing erroneous observations using Python programming language technology to obtain daily meteorological information, and then converting the daily meteorological information into monthly meteorological information.

Step S2, based on the monthly meteorological information obtained in the step S2, calculating monthly potential evapotranspiration (PET) information of a station according to the FAO (abbreviation for food and agriculture organization of the United Nations) Penman-Monteith formula.

Specifically, a calculation formula of the PET is as follows:

$$PET = \frac{0.408 Δ ( {R}_{n} - G ) + γ \frac{900}{T + 273} {μ}_{2} ( {e}_{a} - {e}_{d} )}{Δ + γ ( 1 + 0.34 {u}_{2} )} ,$$

where, Δ represents a slope of a relationship curve between saturation vapor pressure and temperature, Rₙ represents a net radiation, G represents a soil heat flux, γ represents a hygrometer constant, T represents a temperature, μ₂ represent an average wind speed, eₐ represents a saturation vapor pressure, and e_{d} represents an actual vapor pressure.

Step S3, calculating differences of precipitation and potential evapotranspiration (precipitation—potential evapotranspiration) according to precipitation information obtained in the step S1 and the potential evapotranspiration information obtained in the step S2; and constructing time series of cumulative differences of precipitation and potential evapotranspiration at multiple time scales (such as 1 month, 3 months, 6 months, 9 months, 12 months, and 24 months).

Specifically, a calculation formula for the cumulative difference of precipitation and potential evapotranspiration is as follows:

X_{i,j}^{k=Σ}ᵢ₌₁₃₋ₖ₊ⱼ¹²D_{i-1,l}+Σᵢ₌₁^{j}D_{i,l},if j<k

X_{i,j}^{k=Σ}ᵢ₌ⱼ₋ₖ₊₁^{j}D_{i,l},if j≥k

where, X_{i,j}^{k} represents a cumulative value of differences of precipitation and potential evapotranspiration at the time scale of k months for a j-th month in an i-th year, and D_{i,l} represents the difference of precipitation and potential evapotranspiration for a l-th month in the i-th year.

Step S4, calculating SPEIs of the station at the different time scales (such as SPEI-1, SPEI-3, SPEI-6, SPEI-9, SPEI-12 and SPEI-24 respectively corresponding to the 1 month, the 3 months, the 6 months, the 9 months, the 12 months and the 24 months), according to information of the time series of cumulative differences of precipitation and potential evapotranspiration at the different time scales obtained in the step S3.

Specifically, a calculation formula of the SPEI is as follows:

$$f ( x ) = \frac{β}{a} {{( \frac{x - γ}{a} )}^{β - 1} [ 1 + {( \frac{x - γ}{a} )}^{β} ]}^{- 2}$$

$$F ( x ) = {[ 1 + {( \frac{a}{x - γ} )}^{β} ]}^{- 1}$$

$$SPEI = \sqrt{- 2 ( In ( P )} - \frac{{c}_{0} + {c}_{1} W + {c}_{2} {W}^{2}}{1 + {d}_{1} W + {d}_{2} {W}^{2} + {d}_{3} {W}^{3}}$$

$$P = 1 - F ( x ) , if F ( x ) \leq 0.5$$

$$P = F ( x ) , if F ( x ) > 0.5$$

where, ƒ(x) represents a probability density function, F(x) represents a probability distribution function, a represents a scale parameter, β represents a shape parameter, γ represents a position parameter, c₀, c₁, c₂, d₁, d₂, and d₃ represent constants each greater than zero, and P represents an intermediate parameter being set for formula simplification. As an implementable embodiment, c₀=2.515517, c₁=0.802853, c₂=0.010328, d₁=1.432788, d₂=0.189269, d₃=0.001308.

Step S5, acquiring GPM (abbreviation for global precipitation measurement) precipitation data, MODIS (abbreviation for moderate-resolution imaging spectroradiometer) land surface temperature data, ERA5-Land shortwave radiation data, and SRTM (abbreviation for shuttle radar topography mission) digital elevation model (DEM) data, based on the Google earth engine (GEE) cloud platform; and performing cloud removal processing on the MODIS land surface temperature data. Herein, ERA5-Land generally refers to an enhanced global dataset for the land component of the 5th generation of European Center for Medium Weather Forecasting (ECMWF) reanalysis (ERA5).

Specifically, the cloud removal processing on the MODIS land surface temperature data is carried out as the following method:
removing clouds, cloud shadows, cirrus clouds, and ice/snow cover observations from satellite images by using a quality band cloud removal algorithm, to thereby obtain a high-quality satellite image dataset.

Step S6, removing seasonality of the precipitation data, the land surface temperature data, and shortwave radiation data obtained in the step S5 and then converting them into monthly data, and then resampling spatial resolutions of the precipitation data, the land surface temperature data, the shortwave radiation data and the elevation data to 1 km by using a bicubic interpolation algorithm.

Step S7, forming sample points by information of the SPEIs obtained in the step S4 and data values at the station of the precipitation data, the land surface temperature data, the shortwave radiation data and the elevation data processed by the step S6.

Step S8, constructing the random forest regression model according to the sample points obtained in the step S7; wherein, 80% of the sample points are randomly selected as training samples, and 20% of the sample points are used as testing samples.

Step S9, inputting precipitation data, land surface temperature data, shortwave radiation data and elevation data obtained in the step S6 into the random forest regression model constructed in the step S8 for prediction, and thereby obtaining a SPEI dataset with a spatial resolution of 1 km for the target area/region in the study/research period (as an implementable embodiment, such as in China from the years 2001 to 2020).

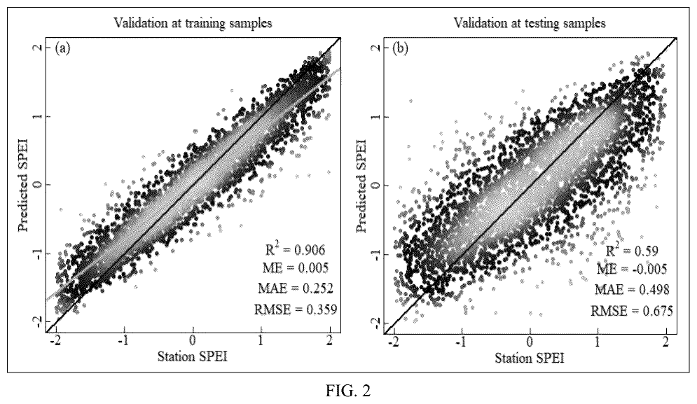

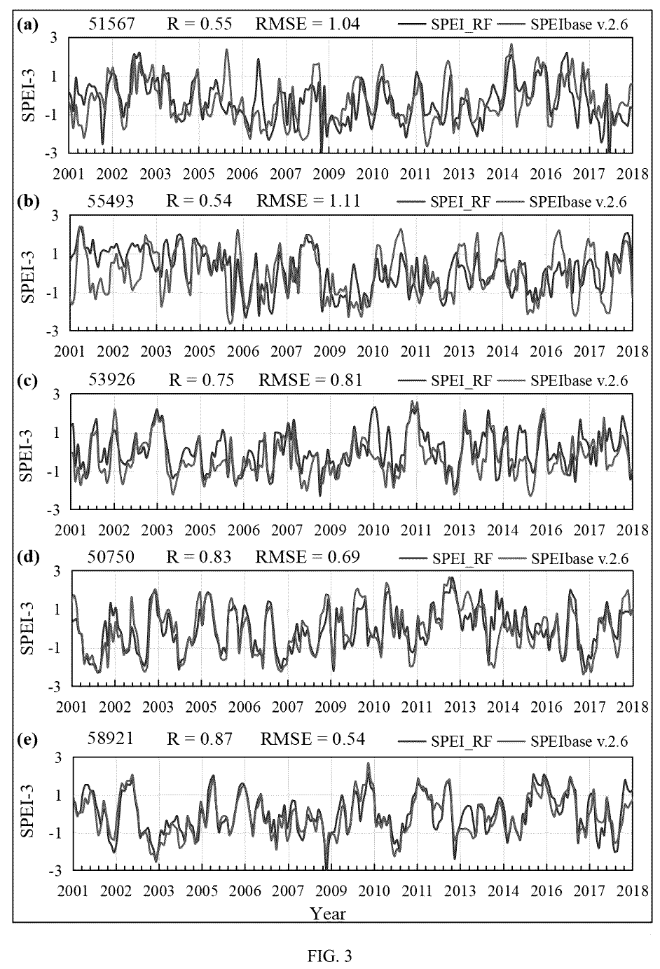

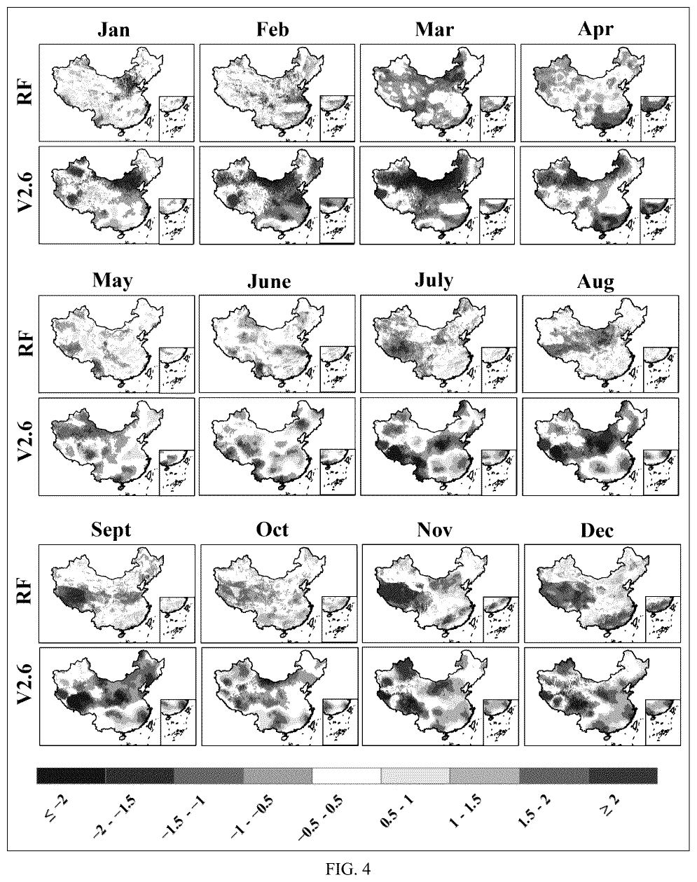

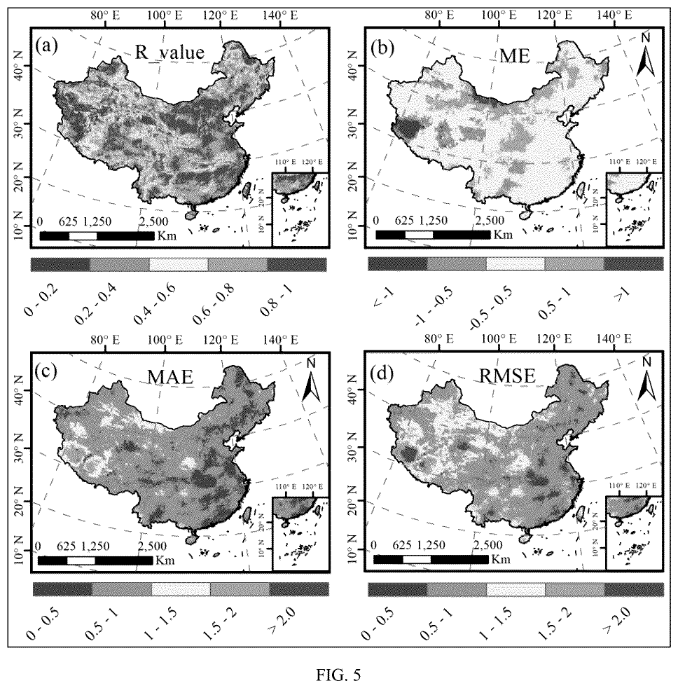

In order to verify an effect of the invention, through the illustrated method of the invention, cross-validation result diagrams of SPEI dataset with spatial resolution of 1 km in China on training samples and testing samples were generated, as shown in FIG. 2. For all the sample points, 80% of the sample points are randomly selected as the training samples, the cross-validation result is illustrated in the diagram denoted by (a) in FIG. 2; and the other 20% sample points are used as the testing samples, and the cross-validation result is illustrated in the diagram denoted by (b) in FIG. 2. As seen from FIG. 2, the random forest regression model used by the method has good stability, high prediction accuracy and is resistant to overfitting; in the training samples, R²=0.906, ME=0.005, MAE=0.252, RMSE=0.359; and in the testing samples, R²=0.59, ME=−0.005, MAE=0.498, RMSE=0.675. Through the illustrated method of the invention, time series change/variation curve diagrams of SPEI from the year 2001 to the year 2018 were generated, as shown in FIG. 3. stations in the northwest, southwest, central, northeast, and southeast regions of China, and SPEIbase v.2.6 dataset wee selected for time series consistency analysis. In FIG. 3, diagrams denoted by (a), (b), (c), (d), and (e) are the time series change curve diagrams of SPEI for five stations: 51567 (Xinjiang), 55493 (Tibet), 53926 (Gansu), 50750 (Heilongjiang), and 58921 (Fujian), respectively; and in each curve diagram, the light curve represents a calculation result of the invention, and the dark curve represents a result of the SPEIbase v.2.6 dataset. In the curve diagram denoted by (a) in FIG. 3, time series change curves of the SPEI obtained by the invention and the SPEIbase v.2.6 both showed that: in the periods of 2001-2003 and 2014-2018, the region where the station 51567 is located is in a humid period, and in the period of 2004-2013, it is in a drought period. In the curve diagram denoted by (b) in FIG. 3, the consistency between the SPEI obtained by the invention and the SPEIbase v.2.6 is relatively low in the period from the year 2001 to the year 2003, the consistency of time series of the two kinds of data is relatively good in the period from the year 2003 to the year 2013; and after the year 2013, the consistency decreased again. Although the two kinds of data have different degrees of differences in specific periods, their trends are highly similar throughout the study period, and their abilities to capture extreme drought events are basically the same, for example, in the periods of 2006-2007, 2009-2010, and 2014-2016, the two kinds of data both monitored severe drought in the region of the station (55493, Tibet). Compared with the curve diagrams denoted by (a) and (b) in FIG. 3, at the three stations in 53926 (Gansu), 50750 (Heilongjiang), and 58921 (Fujian) corresponding to the curve diagrams denoted by (c), (d) and (e) in FIG. 3, the data consistency of the SPEI obtained by the invention and the SPEIbase v.2.6 is significantly improved (R>0.7, RMSE<0.9), mainly owing to meteorological stations in northwest China and the Qinghai-Tibet Plateau are less in distribution, so that enough training samples are difficult to obtain when the random forest model is constructed, and thus compared with the central, northeast and southeast regions, the model stability is more uncertain. Through the illustrated method of the invention, monthly SPEI spatial distribution diagrams for the year 2015 were generated, as shown in FIG. 4. In particular, in each group of diagrams, the upper diagram represents a result of the invention, and the lower diagram represents a result of SPEIbase v.2.6. In the year 2015, the most severe drought in China occurs in March, and the wettest period is June. More specifically, in January 2015, the drought in central Inner Mongolia, western Liaoning and Hebei was very severe; in February 2015, the drought spread to southern China, while the Qinghai-Tibet Plateau, Yunnan, Guizhou and Northeast China were relatively humid; in March 2015, the drought area reached the highest value of the whole year, the drought intensity was further increased, and the western region of China, which was relatively humid, also suffered a very serious drought disaster; in April 2015, the drought began to weaken gradually, and the North China Plain began to enter a humid state, regions with serious drought were mainly distributed in Inner Mongolia, Xinjiang, Guizhou and Guangdong; in May 2015, the drought in the eastern region of China was further weakened, and although the western region was still in drought, the intensity and area of drought decreased; in June 2015, the whole territory of China entered the wettest period of the year, except for the southern region of the Qinghai-Tibet Plateau, southern Sichuan, Yunnan and Guangxi, which were still in drought, all other regions entered wet states; in July 2015, the second round of drought in the whole year started, the Qinghai-Tibet Plateau and the North China Plain entered severe drought states, Xinjiang entered a moderate drought state, and the southeast region entered a humid period due to the increase of precipitation; in August 2015, the drought in the Qinghai-Tibet Plateau and the North China Plain spread to the central region, forming an arid zone extending from southwest to northeast, while the southeast region was still in a humid period; in September 2015, the arid zone further spread to the northeast region, and the drought in the Qinghai-Tibet Plateau was further aggravated; in October 2015, the drought in the Qinghai-Tibet Plateau was significantly weakened, and Xinjiang also entered the humid period, the drought was mainly concentrated in the Qinghai-Tibet Plateau, Qinghai and Gansu; in November 2015, the drought in the Tibetan Plateau intensified again, and other regions entered the humid period; and in December 2015, the drought area in the Qinghai-Tibet Plateau was further expanded, while the drought intensity was weakened, and the dry and wet conditions in other regions did not change significantly. A high consistency of the SPEI dataset obtained by the illustrated method of the invention with the SPEIbase V. 2.6 dataset in spatial distribution fully proves the reliability of the illustrated method of the invention. Through the illustrated embodiment of the invention, SPEI spatial accuracy evaluation result diagrams were generated, as shown in FIG. 5. The diagrams denoted by (a), (b), (c) and (d) in FIG. 5 are respectively spatial distribution diagrams of Pearson correlation coefficient (R), mean error (ME), mean absolute error (MAE), root mean square error (RMSE) of results of the invention and the SPEIbase v.2.6. As seen from the diagram denoted by (a) in FIG. 5, the SPEI generated by the illustrated method of the invention is highly correlated with the SPEIbase v.2.6 dataset, and R values in other regions are higher than 0.6 except for the regions in the western region of the Qinghai-Tibet Plateau and the southern region of Xinjiang, where the correlation coefficient is lower than 0.4 due to station scarcity. A mean error (ME) result illustrated in the diagram denoted by (b) in FIG. 5 showed that: the mean error of the SPEI generated by the illustrated method of the invention and the SPEIbase v.2.6 dataset is between −0.5 and 0.5, and drought spatiotemporal patterns represented by the two kinds of datasets are completely consistent. Results of mean absolute error (MAE) and root mean square error (RMSE) illustrated in the diagrams denoted by (c) and (d) in FIG. 5 are similar to the result of mean error in the diagram denoted by (b) in FIG. 5, the mean absolute error and the root mean square error of the SPEI generated by the illustrated method of the invention and the SPEIbase v.2.6 dataset were both less than 1, which fully verify the accuracy of the SPEI dataset generated by the illustrated method of the invention.

The foregoing is only preferred embodiments of the invention. It should be noted that for those skilled in the art, several improvements and modifications can be made without departing from the principle of the invention. These improvements and modifications should also be considered as the scope of protection of the invention.

What is claimed is:

1. A high-resolution standardized precipitation evapotranspiration index (SPEI) dataset development method based on a random forest regression model, comprising:
step 1, acquiring daily meteorological station information of a target area in a study period through a national meteorological science data center and removing erroneous observations using Python programming language technology to obtain daily meteorological information, and then converting the daily meteorological information into monthly meteorological information;
step 2, based on the monthly meteorological information obtained in the step 1, calculating monthly potential evapotranspiration (PET) information at a station according to the FAO Penman-Monteith formula;
step 3, calculating differences of precipitation and potential evapotranspiration according to precipitation information obtained in the step 1 and the potential evapotranspiration information obtained in the step 2, and constructing time series of cumulative differences of precipitation and potential evapotranspiration at multiple time scales;
step 4, calculating SPEIs at different time scales of the station according to information of the time series of cumulative differences of precipitation and potential evapotranspiration at the different time scales obtained in the step 3;
step 5, acquiring global precipitation measurement (GPM) precipitation data, moderate-resolution imaging spectroradiometer (MODIS) land surface temperature data, ERA5-Land shortwave radiation data, and shuttle radar topography mission (SRTM) digital elevation data, based on a Google earth engine (GEE) cloud platform; and performing cloud removal processing on the MODIS land surface temperature data;
step 6, removing seasonality of the precipitation data, the land surface temperature data, and shortwave radiation data obtained in the step 5 and then converting into monthly data, and then resampling spatial resolutions of the precipitation data, the land surface temperature data, the shortwave radiation data and the elevation data to 1 kilometer (km) through a bicubic interpolation algorithm;
step 7, forming sample points by information of the SPEIs at the different time scales obtained in the step 4 and data values at the station of the precipitation data, the land surface temperature data, the shortwave radiation data and the elevation data processed by the step 6;
step 8, constructing the random forest regression model according to the sample points obtained in the step 7; and
step 9, inputting the precipitation data, the land surface temperature data, the shortwave radiation data and the elevation data obtained in the step 6 into the random forest regression model constructed in the step 8 for prediction, to thereby obtain a SPEI dataset with a spatial resolution of 1 km for the target area in the study period.

2. The high-resolution SPEI dataset development method based on the random forest regression model as claimed in claim 1, wherein in the step 2, the potential evapotranspiration information is calculated as follows:
$$PET = \frac{0.408 Δ ( {R}_{n} - G ) + γ \frac{900}{T + 273} {μ}_{2} ( {e}_{a} - {e}_{d} )}{Δ + γ ( 1 + 0.34 {u}_{2} )}$$
where Δ represents a slope of a relationship curve between saturation vapor pressure and temperature, Rₙ represents a net radiation, G represents a soil heat flux, γ represents a hygrometer constant, T represents a temperature, μ₂ represent an average wind speed, eₐ represents a saturation vapor pressure, and e_{d} represents an actual vapor pressure.

3. The high-resolution SPEI dataset development method based on the random forest regression model as claimed in claim 1, wherein in the step 3, the cumulative difference of precipitation and potential evapotranspiration is calculated as follows:
X_{i,j}^{k=Σ}ᵢ₌₁₃₋ₖ₊ⱼ¹²D_{i-1,l}+Σᵢ₌₁^{j}D_{i,l},if j<k
X_{i,j}^{k=Σ}ᵢ₌ⱼ₋ₖ₊₁^{j}D_{i,l},if j≥k
where X_{i,j}^{k} represents a cumulative value of differences of precipitation and potential evapotranspiration at the time scale of k months for a j-th month in an i-th year, and D_{i,l} represents the difference of precipitation and potential evapotranspiration for a l-th month in the i-th year.

4. The high-resolution SPEI dataset development method based on the random forest regression model as claimed in claim 1, wherein in the step 4, the SPEI is calculated as follows:
$$f ( x ) = \frac{β}{a} {{( \frac{x - γ}{a} )}^{β - 1} [ 1 + {( \frac{x - γ}{a} )}^{β} ]}^{- 2}$$
$$F ( x ) = {[ 1 + {( \frac{a}{x - γ} )}^{β} ]}^{- 1}$$
$$SPEI = \sqrt{- 2 ln ( P )} - \frac{{c}_{0} + {c}_{1} W + {c}_{2} {W}^{2}}{1 + {d}_{1} W + {d}_{2} {W}^{2} + {d}_{3} {W}^{3}}$$
$$P = 1 - F ( x ) , if F ( x ) \leq 0.5$$
$$P = F ( x ) , if F ( x ) > 0.5$$
where ƒ(x) represents a probability density function, F(x) represents a probability distribution function, a represents a scale parameter, β represents a shape parameter, γ represents a position parameter, c₀, c₁, c₂, d₁, d₂, and d₃ represent constants each greater than zero, and P represents an intermediate parameter.

5. The high-resolution SPEI dataset development method based on the random forest regression model as claimed in claim 1, wherein in the step 5, the cloud removal processing is performed as follows:
removing clouds, cloud shadows, cirrus clouds, and ice and snow cover observations from satellite images through a quality band cloud removal algorithm, to thereby obtain a high-quality satellite image dataset.
